(19) United States
(12) Patent Application Publication
(10) Pub. No.: US 2005/0286663 A1
(43) Pub. Date: Dec. 29, 2005

(54) Compact feedback for closed loop MIMO systems

(75) Inventor: Ada S. Y. Poon, Emeryville, CA (US)

Correspondence Address: LeMoine Patent Service, PLLC;c/o PortfolioIP, P.O. Box 52050, Minneapolis, MN, 55402, US

(73) Assignee: Intel Corporation

(21) Appl. No.: 10/874,710

(22) Filed: Jun. 23, 2004

(51) Int. Cl. H04B 7/08

(52) U.S. Cl. 375/347

(57) ABSTRACT

Stations in a N×N multiple-input-multiple-output (MIMO) wireless network search codewords in a codebook to determine which codeword is closest to a desired pre-coding matrix on a Grassmann manifold. An index or indices corresponding to codeword is transmitted from a receiver to a transmitter to identify a codeword to be used for transmit beamforming.

### FIELD

The present invention relates generally to wireless networks, and more specifically to wireless networks that utilize multiple spatial channels.

### BACKGROUND

Closed loop multiple-input-multiple-output (MIMO) systems typically transmit channel state information from a receiver to a transmitter. Transmitting the channel state information consumes bandwidth that would otherwise be available for data traffic.

### BRIEF DESCRIPTION OF THE DRAWINGS

FIG. 1 shows a diagram of two wireless stations;

FIGS. 2 and 3 show simulation results;

FIGS. 4 and 5 show flowcharts in accordance with various embodiments of the present invention; and

FIG. 6 shows an electronic system in accordance with various embodiments of the present invention.

### DESCRIPTION OF EMBODIMENTS

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

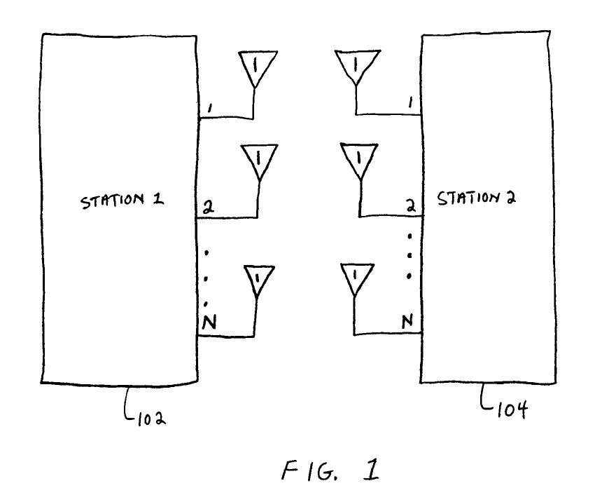

FIG. 1 shows a diagram of two wireless stations: station 102, and station 104. In some embodiments, stations 102 and 104 are part of a wireless local area network (WLAN). For example, one or more of stations 102 and 104 may be an access point in a WLAN. Also for example, one or more of stations 102 and 104 may be a mobile station such as a laptop computer, personal digital assistant (PDA), or the like.

In some embodiments, stations 102 and 104 may operate partially in compliance with, or completely in compliance with, a wireless network standard. For example, stations 102 and 104 may operate partially in compliance with a standard such as ANSI/IEEE Std. 802.11, 1999 Edition, although this is not a limitation of the present invention. As used herein, the term “802.11” refers to any past, present, or future IEEE 802.11 standard, including, but not limited to, the 1999 edition.

Stations 102 and 104 each include multiple antennas. Each of stations 102 and 104 includes “N” antennas, where N may be any number. In some embodiments, stations 102 and 104 have an unequal number of antennas. The remainder of this description discusses the case where stations 102 and 104 have an equal number of antennas, but the various embodiments of the invention are not so limited. The “channel” through which stations 102 and 104 communicate may include many possible signal paths. For example, when stations 102 and 104 are in an environment with many “reflectors” (e.g. walls, doors, or other obstructions), many signals may arrive from different paths. This condition is known as “multipath.” In some embodiments, stations 102 and 104 utilize multiple antennas to take advantage of the multipath and to increase the communications bandwidth. For example, in some embodiments, stations 102 and 104 may communicate using Multiple-Input-Multiple-Output (MIMO) techniques. In general, MIMO systems offer higher capacities by utilizing multiple spatial channels made possible by multipath.

In some embodiments, stations 102 and 104 may communicate using orthogonal frequency division multiplexing (OFDM) in each spatial channel. Multipath may introduce frequency selective fading which may cause impairments like inter-symbol interference (ISI). OFDM is effective at combating frequency selective fading in part because OFDM breaks each spatial channel into small subchannels such that each subchannel exhibits a more flat channel characteristic. Scaling appropriate for each subchannel may be implemented to correct any attenuation caused by the subchannel. Further, the data carrying capacity of each subchannel may be controlled dynamically depending on the fading characteristics of the subchannel.

MIMO systems may operate either “open loop” or “closed loop.” In open loop MIMO systems, a station estimates the state of the channel without receiving channel state information directly from another station. In general, open loop systems employ exponential decoding complexity to estimate the channel. In closed loop systems, communications bandwidth is utilized to transmit current channel state information between stations, thereby reducing the necessary decoding complexity, and also reducing overall throughput. The communications bandwidth used for this purpose is referred to herein as “feedback bandwidth.” When feedback bandwidth is reduced in closed loop MIMO systems, more bandwidth is available for data communications.

Three types of receiver architectures for MIMO systems include: linear, iterative, and maximum-likelihood (ML). In open-loop operation, ML receivers have much better performance than linear and iterative receivers. For example, at 1% packet error rate and 4×36 Mbps, ML receivers are 12 dB more power efficient than linear and iterative receivers, or equivalently, have four times better propagation range. However, ML receivers need 2×10⁵ times more multiplication operations than linear and iterative receivers.

To approach the performance of ML receivers with the complexity of linear receivers, and to reduce the feedback bandwidth, the various embodiments of the present invention utilize codebooks known to both the transmitter and receiver. The codebooks hold pre-coding information that a transmitter may use for beamforming. A receiver identifies the codebook elements for the transmitter to use by transmitting indices identifying the codebook elements. In some embodiments, codebooks are found searched using geometric techniques involving differentiable manifolds, such as Grassmann manifolds. Discussions of Grassmann manifolds may be found in: W. M. Boothby, An Introduction to Differentiable Manifolds and Riemannian Geometry, 2nd Ed., Academic Press, 1986 (the Boothby reference); and J. H. Conway, R. H. Hardin and N.J. A. Sloane, “Packing lines, planes, etc.: packings in Grassmannian spaces,” Experimental Mathematics, vol. 5, No. 2, pp. 139-159, 1996 (the Conway reference). Mathematical descriptions are provided below.

Let the input/output (I/O) model be
y=Hx+z
where xᵢ is the signal on the ith transmit antenna, yᵢ is the signal received at the ith receive antenna, Hᵢⱼ is the channel gain from the jth transmit antenna to the ith receive antenna, and zᵢ is the noise on the ith receive antenna. In closed-loop MIMO, the transmitter may apply a pre-coding matrix P to the signal for beamforming and the I/O model becomes
   y=HPx+z

Upon singular value decomposition (SVD), we have
H=UΣV^{y}
where U and V are N×N unitary matrices, and τ is a diagonal matrix with positive entries. Matrix V may be used as the transmit beamforming matrix, in which case P=V. When P=V, the elements of V may be quantized and sent back to the transmitter, resulting in significant feedback bandwidth usage.

In some embodiments, the desired pre-coding matrix P may be of lesser dimensionality than V. For example, if less than N spatial channels are to be used in an N×N MIMO system, then the number of columns in P may be reduced by the number of unutilized spatial channels. In various embodiments of the present invention, any number of spatial channels may be utilized. The number of spatial channels to be utilized is denoted by M, where M≦N.

Various embodiments of the present invention utilize different codebooks and different codebook searching techniques. To aid in this description, two broad categories of codebooks are defined in the sections that follow: codebooks of beamforming matrices, and codebooks of beamforming vectors. This categorization is useful for pedagogical reasons only, and is not meant to limit the various embodiments of the present invention. For example, some embodiments of the present invention include elements from both categories.

### Category 1: Codebooks of Beamforming Matrices

Suppose the desired pre-coding matrix P is the first M columns of V. The desired pre-coding matrix P may be viewed as a point on the Grassmann manifold, G(N,M), which is a set of M-dimensional hyper-planes in an N-dimensional space. The dimensionality of the set G(N,M) is only M(N-M) which is less than the number of real coefficients in P, 2N². The Grassmann manifold G(N,M) may be quantized into equal portions. The different portions may be searched to determine in which portion P is located and the corresponding index may then be sent back to the transmitter. This quantization scheme requires the receiver to compare P with a codebook of N×M unitary matrices and the complexity is on the order of 2^{Q}N³ where 2^{Q} is the number of elements in the codebook. The transmitter then uses the codebook element identified by the transmitted index as the pre-coding matrix for beamforming.

### Generation of Codebooks of Beamforming Matrices

The codebook θ contains 2^{Q} elements of G(N,M). The elements in the codebook are referred to herein as “codewords.” In some embodiments, codewords are found by searching for the optimal packing of a set of M-dimensional hyper-planes in the N-dimensional space. Closed-form solution for the optimal set does not currently exist in most cases, and the Conway reference cited above provides a study on optimal sets mostly obtained from extensive computer searches. In various embodiments of the present invention, codebooks of beamforming matrices may be found using computer search techniques.

In some embodiments, a set of candidate codebooks C are generated randomly and then the candidate codebooks are searched to find a codebook θ having particular properties. For example a codebook θ may be found by:

$$ϑ = {arg max}_{C ⋐ G ( N , M )} ( {max}_{{C}_{1} , {C}_{2} ∈ C} tra ( {C}_{1} {C}_{1}^{+} {C}_{2} {C}_{2}^{+} ) ) \qquad ( 1 )$$

where C₁ and C₂ are codewords in a candidate codebook of beamforming matrices, and θ is a codebook that maximizes the minimum distance between elements of C. The “max tra” operators find the minimum distance between each set of two points in candidate codebook C. The “arg max” operators find the candidate codebook C that has the maximum minimum distance and identifies it as θ. A codebook generated in this manner is included in Table 1 for a 4×4 MIMO system with Q=3 and M=3.

TABLE 1

${C}_{1} = [ \begin{matrix}- .47 - j .48 & 0.5 - j .51 & .31 - j .18 \\ - .33 - j .02 & - .28 - j .19 & 0.45 + j .40 \\ - .19 + j .18 & - .01 - j .24 & .60 + j .36 \\ - .33 - j .51 & - .26 + j .71 & .14 - j .03\end{matrix} ]$
${C}_{2} = [ \begin{matrix}- .62 - j .03 & .60 + j .19 & - .31 + j .34 \\ .21 + j .24 & .56 + j .03 & - .14 - j .70 \\ .46 + j .34 & .24 + j .38 & - .04 + j .20 \\ - .17 - j .38 & .26 - j .15 & .52 - j .13\end{matrix} ]$
${C}_{3} = [ \begin{matrix}- .25 - j .36 & .27 - j .13 & .12 + j .19 \\ .45 + j .42 & - .29 - j .19 & - .01 + j .67 \\ - .11 + j .36 & - .26 - j .38 & .68 - j .06 \\ - .07 - j .54 & - .31 + j .69 & - .10 + j .15\end{matrix} ]$
${C}_{4} = [ \begin{matrix}- .01 - j .65 & .48 + j .17 & .36 + j .33 \\ .14 - j .06 & - .66 + j .31 & .30 - j .22 \\ - .40 + j .35 & .16 + j .33 & - .36 + j .11 \\ - .46 - j .25 & .27 - j .06 & .34 - j .60\end{matrix} ]$
${C}_{5} = [ \begin{matrix}- .34 - j .16 & - .44 + j .38 & .12 - j .41 \\ .66 + j .17 & - .19 - j .10 & .01 - j .67 \\ - .12 + j .01 & .33 - j .65 & - .37 + j .22 \\ .22 - j .57 & .29 - j .05 & .41 - j .09\end{matrix} ]$
${C}_{6} = [ \begin{matrix}- .67 - j .42 & - .03 - j .05 & .03 + j .15 \\ .10 + j .09 & - .58 + j .62 & .42 - j .05 \\ .03 - j .49 & - .01 - j .17 & .66 - j .18 \\ - .07 - j .34 & .43 - j .26 & .57 - j .06\end{matrix} ]$
${C}_{7} = [ \begin{matrix}j .16 & .03 - j .05 & - .21 - j .22 \\ - .20 - j .02 & - .58 - j .62 & - .90 - j .05 \\ .04 + j .77 & .01 - j .17 & .07 - j .28 \\ - .51 - j .29 & .43 + j .26 & - .10 - j .07\end{matrix} ]$
${C}_{8} = [ \begin{matrix}.67 - j .42 & .03 - j .05 & .32 - j .67 \\ - .10 + j .09 & .58 - j .62 & - .12 - j .23 \\ - .03 + j .49 & - .01 + j .17 & .44 - j .33 \\ - .07 + j .34 & .43 - j .26 & .17 + j .23\end{matrix} ]$

### Searching Codebooks of Beamforming Matrices

As described above, the receiver may compute the desired pre-coding matrix P using singular value decomposition. In various embodiments of the present invention, P is compared with elements of codebook θ to find the beamforming matrix that is closest to desired pre-coding matrix P. An index corresponding to the codebook element is then identified for transmission back to the transmitter. For example, an index may be identified by:

$$i = {arg max}_{{iC}_{i} ∈ ϑ} tra ( {C}_{i} {C}_{i}^{+} {PP}^{+} ) \qquad ( 2 )$$

where Cᵢ are beamforming matrices that are elements of codebook θ, and i is the index of the codebook element closest to P. The receiver then transmits i back to the transmitter, and the transmitter may then utilize the beamforming matrix identified by the index i since it has a copy of the codebook. The index i is Q bits in length, and the codebook includes 2^{Q} elements; as a result, the feedback bandwidth depends on the size of the codebook.

### Simulation Results Using Codebooks of Beamforming Matrices

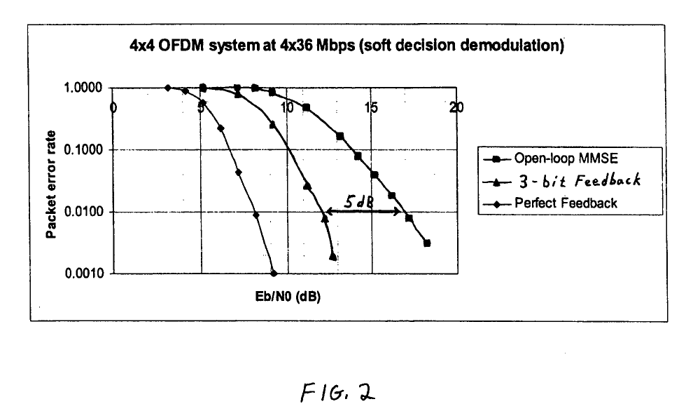

FIG. 2 shows simulation results comparing the performance of one embodiment of the present invention, as well as the performance of a linear system and a system with perfect feedback (infinite precision). The performance measure shown in FIG. 2 plots the packet error rate vs. E_{b}/N₀ of a 4×4 48-tone OFDM system using a 64-state convolutional code, space-time interleaver, and 64-QAM with hard-decision demodulation. As can be seen in FIG. 2, as compared with the open-loop MMSE (linear receiver) having comparable decoding complexity, embodiments using codebooks of eight beamforming matrices (Q=3) perform approximately 5 dB better. Further, embodiments represented by FIG. 2 only transmit three bits of feedback information, which significantly reduces the feedback bandwidth.

### Category 2:Codebooks of Beamforming Vectors

The columns of the desired pre-coding matrix P may be viewed as transmit beamforming vectors because they give the direction of strong paths between the transmitter and the receiver. Column vectors of P may also be viewed as points on the Grassmann manifold G(N,1), which is a set of points on an N-dimensional hyper-sphere. The Grassmann manifold G(N,1) may be quantized into equal portions. In embodiments in which the codebook includes vectors, each column of P is quantized individually rather than P being quantized as a whole, and quantization complexity may be reduced from order N³ to order NM.

### Generation of Codebooks of Beamforming Vectors

The codebook θ contains a set of points on the N-dimensional hyper-sphere, that is, it is a subset of G(N,1). In some embodiments, codewords are found by searching for the optimal packing of a set of points on this N-dimensional surface. In various embodiments of the present invention, codebooks of beamforming vectors may be found using computer search techniques.

In some embodiments, a set of candidate codebooks C are generated randomly and then the candidate codebooks are searched to find a codebook θ having particular properties. For example a codebook θ may be found by:

$$ϑ = {arg max}_{C ⋐ G ( N , 1 )} ( {max}_{{c}_{1} , {c}_{2} ∈ C} \vert {c}_{1}^{+} {c}_{2} \vert ) \qquad ( 3 )$$

where c₁ and c₂ are elements of a candidate codebook of beamforming vectors, and θ is a codebook that maximizes the minimum distance between points of C.

### Searching Codebooks of Beamforming Vectors

As described above, the receiver may compute the desired pre-coding matrix P using singular value decomposition. In various embodiments of the present invention, each column of P is compared with elements of codebook θ to find a closest beamforming vector. Indices corresponding to each beamforming vector found are then identified for transmission back to the transmitter. For example, an index may be identified by:

$${i}_{n} = {arg max}_{{i}_{n} : {c}_{{i}_{n}} ∈ ϑ} \vert {c}_{{i}_{n}}^{+} {p}_{n} \vert \qquad ( 4 )$$

where pₙ is a column vector of P, cᵢ_{ₙ}, are beamforming vectors that are elements of codebook θ, and iₙ is the index of the codebook element closest to pₙ. The receiver then transmits the index set {i₁,i₂, . . . ,i_{M}} back to the transmitter, and the transmitter may then utilize the set of beamforming vectors identified by the set of indices since it has a copy of the codebook. The feedback bandwidth is then equal to MQ where 2^{Q} is the number of elements in the codebook. As compared to the matrix codebook embodiments described above, the number of feedback bits is MQ instead of Q, but the complexity is on the order of NM instead of N³. Accordingly, there is a trade-off between the number of feedback bits and the quantization complexity.

### Simulation Results Using Codebooks of Beamforming Vectors

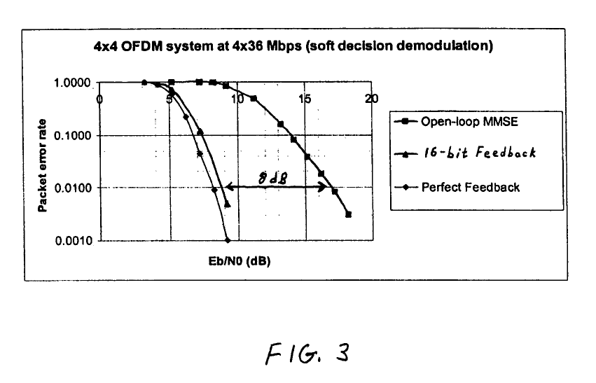

FIG. 3 shows simulation results comparing the performance of one embodiment of the present invention, as well as the performance of a linear system and a system with perfect feedback (infinite precision). The performance measure shown in FIG. 3 plots the packet error rate vs. E_{b}/N₀ of a 4×4 48-tone OFDM system using a 64-state convolutional code, space-time interleaver, and 64-QAM with hard-decision demodulation. As can be seen in FIG. 3, as compared with perfect feedback (infinite precision), the performance of the proposed quantization scheme is degraded by less than 1 dB. The feedback bandwidth is only 16 bits which still results in a substantial reduction in feedback bandwidth. Further, embodiments with vector codebooks perform approximately 8 dB better as compared to open-loop MMSE (linear receiver) having comparable decoding complexity.

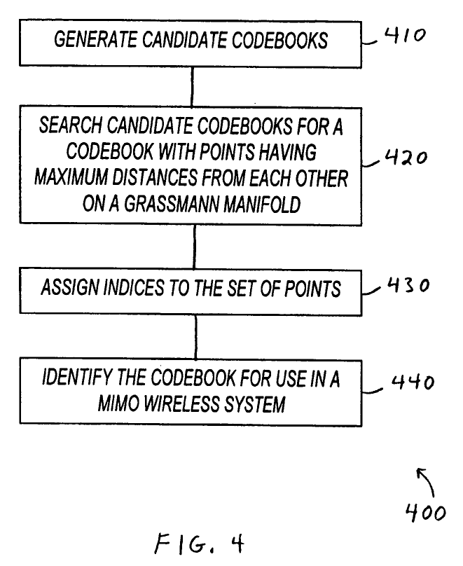

FIG. 4 shows a flowchart in accordance with various embodiments of the present invention. In some embodiments, method 400 may be used in, or for, a wireless system that utilizes MIMO technology. In some embodiments, method 400, or portions thereof, is performed by a wireless communications device, embodiments of which are shown in the various figures. In other embodiments, method 400 is performed by a processor or electronic system. Method 400 is not limited by the particular type of apparatus or software element performing the method. The various actions in method 400 may be performed in the order presented, or may be performed in a different order. Further, in some embodiments, some actions listed in FIG. 4 are omitted from method 400.

Method 400 is shown beginning at block 410 in which candidate codebooks are generated. In some embodiments, candidate codebooks are generated randomly using a computer. At 420, the candidate codebooks are searched for a codebook with points having maximum distances from each other on a Grassmann manifold. In some embodiments, the set of points may correspond to beamforming matrices useful in a MIMO wireless system, and in other embodiments, the set of points may correspond to beamforming vectors useful in a MIMO wireless system. In some embodiments, block 420 corresponds to searching for points on the Grassmann manifold, G(N,M), which is a set of M-dimensional hyper-planes in an N-dimensional space. For example block 420 may correspond to performing the calculations of equation (1) above. In other embodiments, block 420 corresponds to searching for points on the Grassmann manifold G(N,1), which is a set of points on an N-dimensional hyper-sphere. For example, block 420 may correspond to performing the calculations of equation (3) above.

At 430, indices are assigned to the set of points in the codebook found at 420. In some embodiments, one index is assigned to each beamforming matrix in the codebook, and in other embodiments, one index is assigned to each beamforming vector in the codebook. At 440, the codebook is identified for use in a MIMO wireless system. In some embodiments, the codebook includes beamforming matrices, and in other embodiments, the codebook includes beamforming vectors. The codebook will be known to transmitters and receivers in a wireless system, so the indices may be transmitted back and forth to identify which codebook elements should be used as pre-coding matrices for beamforming.

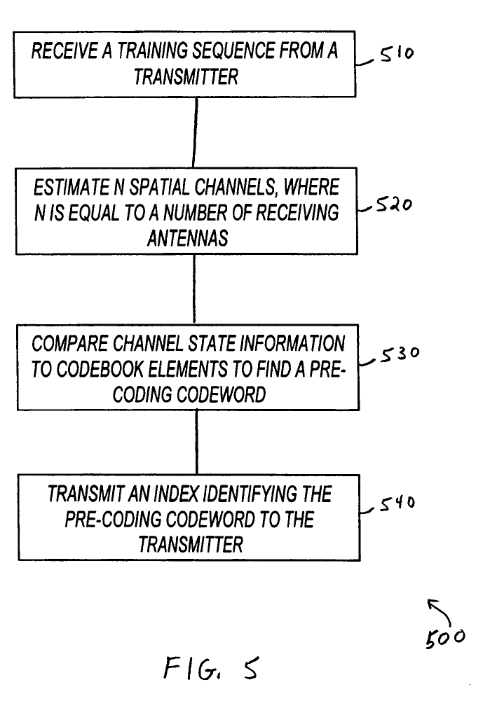

FIG. 5 shows a flowchart in accordance with various embodiments of the present invention. In some embodiments, method 500 may be used in a wireless system that utilizes MIMO technology. In some embodiments, method 500, or portions thereof, is performed by a receiver in a wireless communications device, embodiments of which are shown in the various figures. In other embodiments, method 500 is performed by a processor or electronic system. Method 500 is not limited by the particular type of apparatus or software element performing the method. The various actions in method 500 may be performed in the order presented, or may be performed in a different order. Further, in some embodiments, some actions listed in FIG. 5 are omitted from method 500.

Method 500 is shown beginning at block 510 in which a receiving station receives a training pattern from a transmitting station. For example, station 102 (FIG. 1) may transmit a training pattern, and station 104 may receive the training pattern. At 520, the receiving station estimates N spatial channels, where N is equal to a number of receiving antennas. In some embodiments, this may correspond to station 104 computing a current channel matrix describing the current state of the N spatial channels.

At 530, the receiving station compares the channel state information to elements in a codebook to find a pre-coding codeword. In some embodiments, the pre-coding codeword corresponds to a beamforming matrix, and in other embodiments, the pre-coding codeword corresponds to one or more beamforming vectors. The channel state information may be compared to elements in a codebook by performing the calculations of equation (2) or equation (4), above.

At 540, an index identifying the pre-coding codeword found at 530 is transmitted to a transmitter. In some embodiments, more than one index corresponding to pre-coding codewords are transmitted. For example, when the codebook includes beamforming vectors, a list of M beamforming vector indices may be transmitted, where M is the number of spatial channels used in a MIMO wireless system.

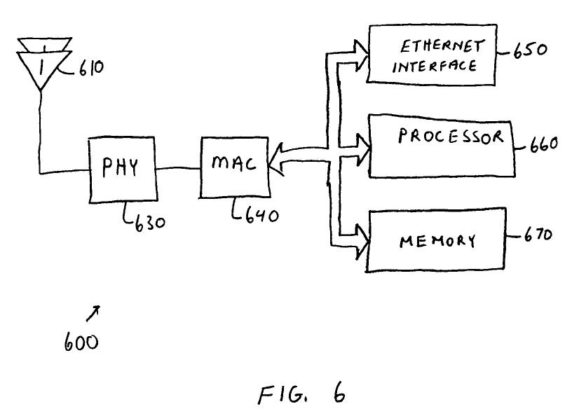

FIG. 6 shows a system diagram in accordance with various embodiments of the present invention. Electronic system 600 includes antennas 610, physical layer (PHY) 630, media access control (MAC) layer 640, Ethernet interface 650, processor 660, and memory 670. In some embodiments, electronic system 600 may be a station capable searching a codebook for elements that most closely match a desired pre-coding matrix found by singular value decomposition of a channel model. In other embodiments, electronic system may be a station that receives an index or indices describing codebook elements to be used for beamforming. For example, electronic system 600 may be utilized in a wireless network as station 102 or station 104 (FIG. 1). Also for example, electronic system 600 may a receiving station capable of performing the calculations shown in equations (2) and (4), above.

In some embodiments, electronic system 600 may represent a system that includes an access point or mobile station as well as other circuits. For example, in some embodiments, electronic system 600 may be a computer, such as a personal computer, a workstation, or the like, that includes an access point or mobile station as a peripheral or as an integrated unit. Further, electronic system 600 may include a series of access points that are coupled together in a network.

In operation, system 600 sends and receives signals using antennas 610, and the signals are processed by the various elements shown in FIG. 6. Antennas 610 may be an antenna array or any type of antenna structure that supports MIMO processing. System 600 may operate in partial compliance with, or in complete compliance with, a wireless network standard such as an 802.11 standard.

Physical layer (PHY) 630 is coupled to antennas 610 to interact with a wireless network. PHY 630 may include circuitry to support the transmission and reception of radio frequency (RF) signals. For example, in some embodiments, PHY 630 includes an RF receiver to receive signals and perform “front end” processing such as low noise amplification (LNA), filtering, frequency conversion or the like. Further, in some embodiments, PHY 630 includes transform mechanisms and beamforming circuitry to support MIMO signal processing. Also for example, in some embodiments, PHY 630 includes circuits to support frequency up-conversion, and an RF transmitter.

Media access control (MAC) layer 640 may be any suitable media access control layer implementation. For example, MAC 640 may be implemented in software, or hardware or any combination thereof. In some embodiments, a portion of MAC 640 may be implemented in hardware, and a portion may be implemented in software that is executed by processor 660. Further, MAC 640 may include a processor separate from processor 660.

In operation, processor 660 reads instructions and data from memory 670 and performs actions in response thereto. For example, processor 660 may access instructions from memory 670 and perform method embodiments of the present invention, such as method 400 (FIG. 4) or method 500 (FIG. 5) or methods described with reference to other figures. Processor 660 represents any type of processor, including but not limited to, a microprocessor, a digital signal processor, a microcontroller, or the like.

Memory 670 represents an article that includes a machine readable medium. For example, memory 670 represents a random access memory (RAM), dynamic random access memory (DRAM), static random access memory (SRAM), read only memory (ROM), flash memory, or any other type of article that includes a medium readable by processor 660. Memory 670 may store instructions for performing the execution of the various method embodiments of the present invention. Memory 670 may also store one or more codebooks of beamforming matrices or beamforming vectors.

Although the various elements of system 600 are shown separate in FIG. 6, embodiments exist that combine the circuitry of processor 660, memory 670, Ethernet interface 650, and MAC 640 in a single integrated circuit. For example, memory 670 may be an internal memory within processor 660 or may be a microprogram control store within processor 660. In some embodiments, the various elements of system 600 may be separately packaged and mounted on a common circuit board. In other embodiments, the various elements are separate integrated circuit dice packaged together, such as in a multi-chip module, and in still further embodiments, various elements are on the same integrated circuit die.

Ethernet interface 650 may provide communications between electronic system 600 and other systems. For example, in some embodiments, electronic system 600 may be an access point that utilizes Ethernet interface 650 to communicate with a wired network or to communicate with other access points. Some embodiments of the present invention do not include Ethernet interface 650. For example, in some embodiments, electronic system 600 may be a network interface card (NIC) that communicates with a computer or network using a bus or other type of port.

Although the present invention has been described in conjunction with certain embodiments, it is to be understood that modifications and variations may be resorted to without departing from the spirit and scope of the invention as those skilled in the art readily understand. Such modifications and variations are considered to be within the scope of the invention and the appended claims.

1. A method comprising:
receiving a training sequence from a transmitter;
estimating channel state information for N spatial channels, wherein N is equal to a number of receiving antennas; and
comparing the channel state information to elements in a codebook to find a pre-coding codeword.

2. The method of claim 1 further comprising transmitting an index identifying the pre-coding codeword to the transmitter.

3. The method of claim 1 wherein comparing the channel state information to elements in a codebook comprises determining a distance between a desired pre-coding matrix and a codebook element on a Grassmann manifold.

4. The method of claim 1 wherein comparing the channel state information to elements in a codebook comprises determining distances between column vectors of a desired pre-coding matrix and codebook elements on a Grassmann manifold.

5. The method of claim 1 wherein estimating channel state information comprises determining a desired pre-coding matrix having N beamforming vectors; and
reducing the dimensionality of the desired pre-coding matrix to include N-1 beamforming vectors.

6. The method of claim 5 wherein comparing the channel state information to elements in a codebook comprises comparing the desired pre-coding matrix to codebook elements on a Grassmann manifold.

7. The method of claim 6 wherein N is equal to four.

8. The method of claim 6 wherein N is equal to three.

9. The method of claim 1 wherein the channel state information describes spatial channels in an orthogonal frequency division multiplexing (OFDM) multiple-input-multiple-output (MIMO) system.

10. A method comprising determining at least one codebook element corresponding to a beamforming matrix in a multiple-input-multiple-output (MIMO) wireless system by comparing a desired pre-coding matrix to the at least one codebook element.

11. The method of claim 10 further comprising transmitting an index corresponding to the at least one codebook element.

12. The method of claim 10 wherein determining at least one codebook element comprises comparing the desired pre-coding matrix as a whole to codebook elements.

13. The method of claim 10 wherein determining at least one codebook element comprises comparing columns of the desired pre-coding to codebook elements.

14. The method of claim 10 wherein the desired pre-coding matrix is of dimension N×N where N is a number of receive antennas.

15. The method of claim 10 wherein the desired pre-coding matrix is of dimension N×N-1 where N is a number of receive antennas.

16. The method of claim 10 wherein the at least one codebook element corresponds to points on a Grassmann manifold.

17. The method of claim 16 wherein comparing a desired pre-coding matrix to the at least one codebook element comprises determining a point on the Grassmann manifold to which the desired pre-coding matrix is closest.

18. A method comprising dividing a Grassmann manifold into equal portions for generating a codebook of pre-coding matrices for use in a multiple-input-multiple-output (MIMO) wireless system.

19. The method of claim 18 wherein dividing the Grassmann manifold into equal portions comprises searching candidate codebooks for a codebook with points having maximum distances from each other.

20. The method of claim 18 further comprising assigning indices to the pre-coding matrices.

21. An article comprising:
a machine-readable medium adapted to hold instructions that when accessed result in a machine determining at least one codebook element corresponding to a beamforming matrix in a multiple-input-multiple-output (MIMO) wireless system by comparing a desired pre-coding matrix to the at least one codebook element.

22. The article of claim 21 wherein determining at least one codebook element comprises comparing the desired pre-coding matrix as a whole to codebook elements.

23. The article of claim 21 wherein determining at least one codebook element comprises comparing columns of the desired pre-coding matrix to codebook elements.

24. The article of claim 21 wherein the desired pre-coding matrix is of dimension N×N where N is a number of receive antennas.

25. The article of claim 21 wherein the desired pre-coding matrix is of dimension N×N-1 where N is a number of receive antennas.

26. An electronic system comprising:
N antennas;
a processor coupled to the N antennas;
an Ethernet interface; and
an article having a machine-readable medium adapted to hold instructions that when accessed result in the processor estimating channel state information for N spatial channels, and comparing the channel state information to codebook elements to find a pre-coding codeword.

27. The electronic system of claim 26 further comprising transmitting an index identifying the pre-coding codeword to a transmitter.

28. The electronic system of claim 26 wherein comparing the channel state information to codebook elements comprises determining a distance between a desired pre-coding matrix and the pre-coding codeword on a Grassmann manifold.
